(19) United States
(12) Patent Application Publication
(10) Pub. No.: US 2015/0247076 A1
(43) Pub. Date: Sep. 3, 2015

(54) POLYMERS COMPRISING A POLYURETHANE BACKBONE ENDCAPPED WITH REACTIVE (METH)ACRYLIC TERMINATING GROUPS AND THEIR USE AS ADHESIVES

(71) Applicant: BASF SE, Ludwigshafen (DE)

(72) Inventors: Huiguang Kou, Mannheim (DE); Dirk Wulff, Schifferstadt (DE); Clemens Auschra, Freiburg (DE); Dario Perera-Diez, Basel (CH)

(73) Assignee: BASF SE, Ludwigshafen (DE)

(21) Appl. No.: 14/428,763

(22) PCT Filed: Sep. 9, 2013
(86) PCT No.: PCT/EP2013/068544

§ 371 Date: Mar. 17, 2015

Related U.S. Application Data
(60) Provisional application No. 61/702,275, filed on Sep. 18, 2012.

(30) Foreign Application Priority Data
Sep. 18, 2012 (EP) 12184820.4

(51) Int. Cl. C09J 175/16; B32B 37/12; C09J 193/04

(52) U.S. Cl. CPC C09J 175/16; C09J 193/04; B32B 37/12; B32B 2037/1253

(57) ABSTRACT

A description is given of a polymer comprising a polyurethane backbone which is endcapped with reactive (meth)acrylic terminating groups, wherein the polyurethane backbone contains polymerized residues of at least one poly(meth)acrylate polyol. The polymer can be used as an adhesive, especially as a pressure-sensitive adhesive or for producing adhesive compositions. The polymer and the compositions can be cured thermally or by radiation.

The invention relates to a polymer comprising a polyurethane backbone which is endcapped with reactive (meth)acrylic terminating groups, wherein the polyurethane backbone contains polymerized residues of at least one poly(meth)acrylate polyol. The polymer can be used as an adhesive, especially as a pressure-sensitive adhesive or for producing adhesive compositions. The polymer and the compositions can be cured thermally or by radiation.

Radiation curable pressure sensitive adhesives (PSA) are of continuing commercial interest as they are typically low viscous with good coatability before curing, can be cured on demand immediately resulting in high production output, reduced work progress, reduced energy consumption, reduced floor space and low or no emissions of VOC or isocyanates.

UV-curable pressure sensitive adhesives based on polyacrylates are for example described in EP 377 199. UV curable (meth)acrylated polyurethanes based on polyetherpolyols are described in U.S. Pat. No. 5,391,602 which refers to a radiation-curable PSA formulation in which the polyurethane is derived from polyoxypropylene/polyoxyethylene diols (PEGs or PPGs). UV curable (meth)acrylated polyurethanes based on polyester polyols are described in U.S. Pat. No. 5,087,686 which refers to radiation curable polyurethane prepolymers capped with acrylates, said polyurethane is derived from polyester diols. UV curable (meth)acrylated polyurethanes based on polybutadiene polyols are described in WO2006117156 which refers to UV curable PSA resins, which are prepared via a chain extension process of diisocyanates with hydrogenated polybutadiene diols.

Though PSAs and PSA articles produced with adhesives based on UV-curable (meth)acrylate polymers or based on polyurethane polymers are known, there continues to be a demand for alternative adhesive polymers having good bonding properties for a multiplicity of very varied fields of application. Of special importance is a good ratio of cohesion (or shear strength) and adhesion (or peel strength). Typically, when improving one of these two properties with one modification of the adhesive system, the other property often gets impaired. Therefore, new adhesive systems are desirable with e.g. improved cohesion and with similar adhesion compared to commercially available UV-curable pressure-sensitive adhesives.

The problem is solved in accordance with the invention by means of a polymer comprising a polyurethane backbone which is endcapped with reactive (meth)acrylic terminating groups, wherein the polyurethane backbone contains polymerized residues of at least one poly(meth)acrylate polyol.

The polymer according to the invention is preferably a radiation curable (meth)acrylated polyurethane based on a hydroxy-substituted telechelic CFRP (controlled free radical polymerization) polyacrylate and at least one diisocyanate compound, which can be used as UV curable PSA resin. The hydroxy-substituted telechelic CFRP polyacrylate can be prepared via nitroxide free radical polymerization. Due to a variety of acrylate monomers and robust nitroxide free radical polymerization method, the properties of OH telechelic polyacrylate, as well as the adhesive performance (adhesion, cohesion, weather stability, solvent/water resistance, mechanical properties, formulability/compatibility, et. al) can be easily adjusted. As a consequence, the invention product shows surprising excellent adhesive effects.

As used herein, the term “(meth)acrylate” and similar designations are used as an abbreviated notation for “acrylate or methacrylate”.

The terms “substituent” or “substituted” as used herein (unless followed by a list of other substituents) signifies the one or more of following groups or substitution by these groups: carboxy, sulpho, formyl, hydroxy, amino, imino, nitrilo, mercapto, cyano, nitro, alkoxy, halo and/or combinations thereof. These optional groups include all suitable chemically possible combinations in the same moiety of a plurality of the aforementioned groups. The synonymous terms “organic substituent” and “organic group” as used herein (also abbreviated herein to “organo”) denote any univalent or multivalent moiety (optionally attached to one or more other moieties) which comprises one or more carbon atoms and optionally one or more other heteroatoms.

A pressure-sensitive adhesive (PSA) is a viscoelastic adhesive whose set film at room temperature (20° C.) in the dry state remains permanently tacky and adhesive. Adherence to substrates is accomplished immediately by gentle application of pressure. A PSA composition is a composition which comprises a polymer that has pressure-sensitive adhesive properties. An adhesive polymer in the sense of the invention is a polymer having a glass transition temperature preferably in the range from −60° C. to −10° C., or from −58 to −20° C.

The reactive (meth)acrylic terminating group is preferably the residue of a hydroxyalkyl (meth)acrylate. The hydroxyalkyl group comprises preferably 1 to 20 or 2 to 10 C-atoms. The hydroxyalkyl (meth)acrylate is preferably selected from hydroxyethyl (meth)acrylate, hydroxypropyl (meth)acrylate and hydroxybutyl (meth)acrylate. Most preferred is 2-hydroxymethyl acrylate.

The poly(meth)acrylate polyol is preferably a poly(meth)acrylate diol which is the reaction product of a dihydroxyalkyl monovinylether and a living polymerization system controlled poly(meth)acrylate (telechelic poly(meth)acrylate). Synthesis of such compounds are described in WO 2011/120947. Suitable dihydroxyalkyl monovinylether compounds are for example alpha,omega-dihydroxy-C2-10 alkyl monovinylether such as e.g. 1,4-butanediol monovinylether.

The poly(meth)acrylate polyols are preferably formed of at least 40 wt. % or at least 60 wt. % or at least 80 wt. % of suitable (meth)acrylate monomers such as e.g. C1 to C20 alkyl (meth)acrylates. Preferred are (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters.

The (meth)acrylate monomers may optionally be copolymerized with further monomers such as ethylenically unsaturated acid monomers, vinyl esters of carboxylic acids comprising up to 20 carbon atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers. These further monomers may be used in amounts from 0 to 60 wt. % or from 0.1 to 40 wt. % or from 0.5 to 20 wt. %. Vinyl esters of carboxylic acids having 1 to 20 C atoms are, for example, vinyl laurate, vinyl stearate, vinyl propionate, Versatic acid vinyl esters, and vinyl acetate. Vinylaromatic compounds contemplated include vinyltoluene, alpha- and para-methylstyrene, alpha-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Vinyl ethers include, for example, vinyl methyl ether and vinyl isobutyl ether. Vinyl ethers of alcohols comprising 1 to 4 C atoms are preferred. As hydrocarbons having 4 to 8 C atoms and two olefinic double bonds, mention may be made of butadiene, isoprene, and chloroprene. Ethylenically unsaturated acid monomers are, for example, ethylenically unsaturated carboxylic acids, ethylenically unsaturated sulfonic acids, and vinylphosphonic acid. Ethylenically unsaturated carboxylic acids used are preferably alpha,beta-monoethylenically unsaturated monocarboxylic and dicarboxylic acids having 3 to 6 C atoms in the molecule. Examples thereof are acrylic acid, methacrylic acid, itaconic acid, maleic acid, fumaric acid, crotonic acid, vinylacetic acid, and vinyllactic acid. Examples of suitable ethylenically unsaturated sulfonic acids include vinylsulfonic acid, styrenesulfonic acid, acrylamidomethylpropane sulfonic acid, sulfopropyl acrylate, and sulfopropyl methacrylate. Preference is given to acrylic acid and methacrylic acid and a mixture thereof, and acrylic acid is particularly preferred.

In one embodiment of the invention the polymer of the invention has a structure of following formula I:

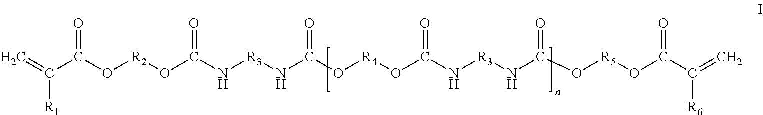

wherein,
R₁ and R₆ are each independently hydrogen or C₁₋₅₀ hydrocarbon fragment,
R₂ and R₅ are each independently C₁₋₅₀ hydrocarbylene,
R₃ is C₁₋₁₀₀ alkyl, aryl, heteroaryl, substituted aryl, and substituted heteroaryl,
R₄ is poly(meth)acrylate segment,
n is a number of 1 to 1000, preferably 10 to 900 or 20 to 800.

Preferably R₁ and R₆ are the same and are hydrogen or C1-10 alkyl or C1-C4 alkyl, most preferably H or methyl.

Preferably R₂ and R₅ are the same and are optionally substituted hydrocarbon group, more preferably C1-36 hydrocarbylene; most preferably C1-8 alkylene, such as C1-4 alkylene, for example ethylene, propylene or butylene.

Preferably R3 is an optionally substituted hydrocarbon group, more preferably a C1-36 hydrocarbylene; most preferably C1-18 arylene or C1-18 alkylene which optionally may comprise one or more aryl groups.

Preferably R4 comprises a poly(meth)acrylate residue of one or more poly(meth)acrylate polyols such as poly(meth)acrylate diols with two hydroxyl functional groups at the end of chains or at the end of pending groups.

Preferably R₄ refers to a structure of following formula II, which for q=0 is a homopolymer segment of (meth)acrylate monomers or for q greater than 0 is a copolymer of (meth)acrylate monomers and other vinyl monomers:

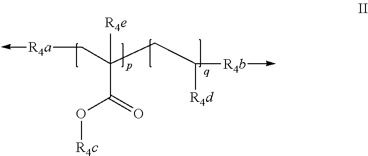

wherein,
R₄ₐ and R_{4b} are each independently an organic residue having 1 to 50 carbon atoms,
R_{4c} is hydrogen, an organic residue having 1 to 50 carbon atoms, such as alkyl, aryl, heteroaryl or substituted aryl,
R_{4d} is an organic residue having 1 to 50 carbon atoms such as aryl, heteroaryl, substituted aryl,
R₄ₑ is hydrogen or C₁₋₅₀ hydrocarbon fragment, preferably methyl,
p is a number of 1 to 500, preferably 2 to 400 or 10 to 200, q is a number of 0 to 100.

The polymer of the invention has a polyurethane backbone. Suitable polyurethane backbones are obtainable in principle through reaction of at least one polyisocyanate with at least one compound which has at least two groups reactive toward isocyanate groups. Polymers of the invention also encompass what are called polyurethane-polyureas, which as well as polyurethane groups also have urea groups.

The polyurethane backbone preferably comprises in copolymerized form at least one polyisocyanate and at least one poly(meth)acrylate polyol. In addition to the poly(meth)acrylate polyol, the polyurethane backbone may be made from further polymeric polyols. Suitable further polymeric polyols are preferably selected from polyester diols, polyether diols, and mixtures thereof. The polymeric polyol preferably has a number-average molecular weight in the range from about 500 to 5000 g/mol. Polymeric diols are preferred. The polyurethane dispersion of the invention preferably comprises at least one polyurethane which comprises in copolymerized form at least one polyisocyanate and a diol component, of which
a) 10-100 mol %, based on the total amount of the diols, have a molecular weight of 500 to 5000 g/mol and
b) 0-90 mol %, based on the total amount of the diols, have a molecular weight of 60 to less than 500 g/mol.

The polyurethane backbone is preferably synthesized to an extent of at least 40% by weight, more preferably at least 60% by weight, and very preferably at least 80% by weight and up to 100% by weight, based on the total weight of the monomers used in preparing the polyurethane backbone, of at least one diisocyanate and at least one poly(meth)acrylate polyol (preferably a diol). Suitable further synthesis components to 100% by weight are, for example, the belowspecified polyisocyanates having at least three NCO groups, and compounds that are different from the poly(meth)acrylate diols and have at least two groups reactive toward isocyanate groups. These include, for example, non-polymeric diols; diamines; polymers different from poly(meth)acrylate polyols and having at least two active hydrogen atoms per molecule; compounds which have two active hydrogen atoms and at least one ionogenic or ionic group per molecule; and mixtures thereof.

The polyurethane backbone is preferably synthesized from
a) at least one monomeric diisocyanate,
b) at least one poly(meth)acrylate polyol, (preferably diol)
c) optionally at least one further diol different from component (b) comprising at least one diol preferably having a number-average molecular weight in the range from 500 to 5000 g/mol,
d) optionally at least one monomer, different from the monomers (a) to (c), having at least one isocyanate group or at least one group reactive toward isocyanate groups, and additionally carrying at least one hydrophilic group or potentially hydrophilic group,
e) optionally at least one further compound, different from the monomers (a) to (d), having at least two reactive groups selected from alcoholic hydroxyl groups, primary or secondary amino groups or isocyanate groups, and
f) optionally at least one monofunctional compound, different from the monomers (a) to (f), having a reactive group which is an alcoholic hydroxyl group, a primary or secondary amino group or an isocyanate group.

Particular mention may be made as monomers (a) of diisocyanates X(NCO)₂, where X is an aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. Diisocyanates of this kind are available commercially.

Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred mixing ratio of the aliphatic to the aromatic isocyanates is 1:9 to 9:1, more particularly 4:1 to 1:4.

Preferred monomeric diisocyanates a) may be selected from the group consisting of 2,4- or 2,6-toluene diisocyanate, diphenyl methane-4,4′-diisocyanate, hydrogenated or non-hydrogenated m-tetramethylene xylene diisocyanate, hexamethylene diisocyanate, isophorone diisocyanate, dicyclohexylmethane diisocyanate, norbornane diisocyanate, 1,5-naphthylene diisocyanate, dimethoxybenzidine diisocyanate or mixtures thereof

The further diols (c) may be polyester polyols, which are known, for example, from Ullmanns Enzyklopädie der technischen Chemie, 4th edition, volume 19, pp. 62 to 65. It is preferred to use polyester polyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cycloaliphatic, araliphatic, aromatic or heterocyclic and can optionally be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preferred dicarboxylic acids are those of the general formula HOOC—(CH₂)_{y}—COOH, where y is a number from 1 to 20, preferably an even number from 2 to 20, examples being succinic acid, adipic acid, sebacic acid, and dodecanedicarboxylic acid. Examples of suitable dihydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl) cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. Preferred alcohols are those of the general formula HO—(CH₂)ₓ—OH, where x is a number from 1 to 20, preferably an even number from 2 to 20. Examples of such alcohols are ethylene glycol, butane-1,4-diol, hexane-1,6-diol, octane-1,8-diol, and dodecane-1,12-diol. Preference is also given to neopentyl glycol.

The further diols (c) may also be polycarbonate diols, such as may be obtained, for example, by reacting phosgene with an excess of the low molecular weight alcohols specified as synthesis components for the polyester polyols. The further diols (c) may also be lactone-based polyester diols, which are homopolymers or copolymers of lactones, preferably hydroxyl-terminated adducts of lactones with suitable difunctional starter molecules. Preferred lactones contemplated are those derived from compounds of the general formula HO—(CH₂)_{z}—COOH, where z is a number from 1 to 20 and where one H atom of a methylene unit may also be substituted by a C₁ to C₄ alkyl radical. Examples are ε-caprolactone, β-propiolactone, γ-butyrolactone and/or methyl-γ-caprolactone, and mixtures thereof. Examples of suitable starter components are the low molecular weight dihydric alcohols specified above as a synthesis component for the polyester polyols. The corresponding polymers of ε-caprolactone are particularly preferred. Lower polyester diols or polyether diols as well can be used as starters for preparing the lactone polymers. Instead of the polymers of lactones it is also possible to use the corresponding chemically equivalent polycondensates of the hydroxycarboxylic acids corresponding to the lactones.

The further diols (c) may also be polyether diols. Polyether diols are obtainable in particular by polymerizing ethylene oxide, propylene oxide, butylene oxide, tetrahydrofuran, styrene oxide or epichlorohydrin with itself, in the presence of BF₃ for example, or by subjecting these compounds, optionally in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polyether diols with a molecular weight of 500 to 5000, and in particular 600 to 4500. A particularly preferred polyether diol is polytetrahydrofuran. Suitable polytetrahydrofurans can be prepared by cationic polymerization of tetrahydrofuran in the presence of acidic catalysts, such as sulfuric acid or fluorosulfuric acid, for example. Preparation processes of this kind are known to the skilled person. Further suitable polyols are polyacetals, polysiloxanes, and alkyd resins with hydroxy groups.

The hardness and the elasticity modulus of the polyurethane backbone can be increased by using as diols not only polymeric diols (b) and (c) but also low molecular weight diols having a molecular weight of from about 60 to less than 500, preferably from 62 to 200 g/mol. Low molecular weight diols are for example unbranched diols having 2 to 12 C atoms and an even number of C atoms, and also pentane-1,5-diol and neopentyl glycol. Examples of suitable diols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentane diols, additionally diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference is further given to neopentyl glycol.

The polyurethane backbone may optionally comprise as synthesis components monomers (d), which carry at least one isocyanate group or at least one group reactive toward isocyanate groups and, furthermore, at least one hydrophilic group or a group which can be converted into a hydrophilic group. In the text below, the term “hydrophilic groups or potentially hydrophilic groups” is abbreviated to “(potentially) hydrophilic groups”. The (potentially) hydrophilic groups react with isocyanates at a substantially slower rate than do the functional groups of the monomers used to synthesize the polymer main chain. The fraction of the components having (potentially) hydrophilic groups among the total quantity of components (a) to (f) is generally such that the molar amount of the (potentially) hydrophilic groups, based on the amount by weight of all monomers (a) to (e), is from 30 to 1000, preferably 50 to 500, and more preferably 80 to 300 mmol/kg. The (potentially) hydrophilic groups can be nonionic or, preferably, (potentially) ionic hydrophilic groups.

Particularly suitable nonionic hydrophilic groups are polyethylene glycol ethers composed of preferably 5 to 100, more preferably 10 to 80 repeating ethylene oxide units. The amount of polyethylene oxide units is generally 0 to 10%, preferably 0 to 6% by weight, based on the amount by weight of all monomers (a) to (f). Preferred monomers containing nonionic hydrophilic groups are polyethylene oxide diols containing at least 20% by weight of ethylene oxide, polyethylene oxide monools, and the reaction products of a polyethylene glycol and a diisocyanate which carry a terminally etherified polyethylene glycol radical. Diisocyanates of this kind and processes for preparing them are specified in U.S. Pat. No. 3,905,929 and U.S. Pat. No. 3,920,598.

Ionic hydrophilic groups are, in particular, anionic groups such as the sulfonate, the carboxylate, and the phosphate groups in the form of their alkali metal salts or ammonium salts, and also cationic groups such as ammonium groups, especially protonated tertiary amino groups or quaternary ammonium groups. Potentially ionic hydrophilic groups are, in particular, those which can be converted into the abovementioned ionic hydrophilic groups by simple neutralization, hydrolysis or quaternization reactions, in other words, for example, carboxylic acid groups or tertiary amino groups. (Potentially) ionic monomers (d) are described at length in, for example, Ullmanns Enzyklopädie der technischen Chemie, 4th edition, volume 19, pp. 311-313 and in, for example, DE-A 1 495 745.

Of particular practical importance as (potentially) cationic monomers (d) are, in particular, monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, and N-aminoalkyldialkylamines, the alkyl radicals and alkanediyl units of these tertiary amines consisting independently of one another of 1 to 6 carbon atoms. Also suitable are polyethers containing tertiary nitrogen atoms and preferably two terminal hydroxyl groups, such as are obtainable in a conventional manner, for example, by alkoxylating amines containing two hydrogen atoms attached to amine nitrogen, such as methylamine, aniline or N,N′-dimethylhydrazine. Polyethers of this kind generally have a molar weight of between 500 and 6000 g/mol. These tertiary amines are converted into the ammonium salts either with acids, preferably strong mineral acids such as phosphoric acid, sulfuric acid, hydrohalic acids, or strong organic acids, or by reaction with suitable quaternizing agents such as C₁ to C₆ alkyl halides or benzyl halides, e.g., bromides or chlorides.

Suitable monomers having (potentially) anionic groups normally include aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 C atoms, such as are also described in U.S. Pat. No. 3,412,054. Particular preference is given to compounds of the general formula

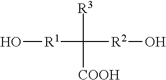

in which R¹ and R² are a C₁ to C₄ alkanediyl (unit) and R³ is a C₁ to C₄ alkyl (unit), and especially to dimethylolpropionic acid (DMPA). Also suitable are corresponding dihydroxysulfonic acids and dihydroxyphosphonic acids such as 2,3-dihydroxypropanephosphonic acid. Otherwise suitable are dihydroxyl compounds having a molecular weight of more than 500 to 10 000 g/mol and at least 2 carboxylate groups, which are known from DE-A 39 11 827. They are obtainable by reacting dihydroxyl compounds with tetracarboxylic dianhydrides such as pyromellitic dianhydride or cyclopentanetetracarboxylic dianhydride in a molar ratio of 2:1 to 1.05:1 in a polyaddition reaction.

Suitable monomers (d) containing amino groups reactive toward isocyanates include aminocarboxylic acids such as lysine, β-alanine or the adducts of aliphatic diprimary diamines with α,β-unsaturated carboxylic or sulfonic acids that are specified in DE-A 20 34 479. Such compounds obey, for example, the formula

H₂N—R⁴—NH—R⁵—X

where R⁴ and R⁵ independently of one another are a C₁ to C₆ alkanediyl unit, preferably ethylene and X is COOH or SO₃H. Particularly preferred compounds are N-(2-aminoethyl)-2-aminoethanecarboxylic acid and also N-(2-aminoethyl)-2-aminoethanesulfonic acid and the corresponding alkali metal salts, with Na being a particularly preferred counterion. Also particularly preferred are the adducts of the abovementioned aliphatic diprimary diamines with 2-acrylamido-2-methylpropanesulfonic acid, as described for example in DE-B 1 954 090.

Where monomers with potentially ionic groups are used, their conversion into the ionic form may take place before, during or, preferably, after the isocyanate polyaddition, since the ionic monomers do not frequently dissolve well in the reaction mixture. Examples of neutralizing agents include ammonia, NaOH, triethanolamine (TEA), triisopropylamine (TIPA) or morpholine, or its derivatives. The sulfonate or carboxylate groups are more preferably in the form of their salts with an alkali metal ion or ammonium ion as counterion.

The monomers (e), which are different from the monomers (a) to (d) and which may also be constituents of the polyurethane backbone, serve generally for crosslinking or chain extension. They generally comprise nonphenolic alcohols with a functionality of more than 2, amines having 2 or more primary and/or secondary amino groups, and compounds which as well as one or more alcoholic hydroxyl groups carry one or more primary and/or secondary amino groups. Alcohols having a functionality of more than 2, which may be used in order to set a certain degree of branching or crosslinking, include for example trimethylolpropane, glycerol, or sugars.

Also suitable are monoalcohols which as well as the hydroxyl group carry a further isocyanatereactive group, such as monoalcohols having one or more primary and/or secondary amino groups, monoethanolamine for example. Polyamines having 2 or more primary and/or secondary amino groups are used especially when the chain extension and/or crosslinking is to take place in the presence of water, since amines generally react more quickly than alcohols or water with isocyanates. Amines suitable are generally polyfunctional amines of the molar weight range from 32 to 500 g/mol, preferably from 60 to 300 g/mol, which comprise at least two amino groups selected from the group consisting of primary and secondary amino groups. Examples of such amines are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane. The amines can also be used in blocked form, e.g., in the form of the corresponding ketimines (see for example CA-A 1 129 128), ketazines (cf., e.g., U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used they are generally mixed with the prepolymers in the absence of water and this mixture is then mixed with the dispersion water or with a portion of the dispersion water, so that the corresponding polyamines are liberated by hydrolysis. It is preferred to use mixtures of diamines and triamines, more preferably mixtures of isophoronediamine (IPDA) and diethylenetriamine (DETA).

For the same purpose it is also possible to use, as monomers (e), isocyanates having a functionality of more than two. Examples of standard commercial compounds are the isocyanurate or the biuret of hexamethylene diisocyanate.

Monomers (f), which are used optionally, are monoisocyanates, monoalcohols, and monoprimary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups which facilitate the dispersing and/or the crosslinking or further polymer-analogous reaction of the polyurethane. Monomers suitable for this purpose include those such as isopropenyl-α,α′-dimethylbenzyl isocyanate (TMI) and esters of acrylic or methacrylic acid such as hydroxyethyl acrylate or hydroxyethyl methacrylate.

Components (a) to (f) and their respective molar amounts are normally chosen so that the ratio A:B, where
A) is the molar amount of isocyanate groups and
B) is the sum of the molar amount of the hydroxyl groups and the molar amount of the functional groups which are able to react with isocyanates in an addition reaction,
   is such that the polyurethane backbone forming polyurethane pre-polymer has terminal isocyanate groups which can further react with e.g. hydroxyalkyl (meth)acrylate to form the polymer of the invention.

The monomers (a) to (f) employed carry on average usually 1.5 to 2.5, preferably 1.9 to 2.1, more preferably 2.0 isocyanate groups and/or functional groups which are able to react with isocyanates in an addition reaction.

The polyaddition of components (a) to (f) for preparing the polyurethane backbone takes place preferably at reaction temperatures of up to 180° C., more preferably up to 150° C., under atmospheric pressure or under autogenous pressure. The preparation of polyurethanes, and of aqueous polyurethane dispersions, is known to the skilled person.

The polymer of the invention preferably has a weight average molecular weight measured by gel permeation chromatography from 100 to 5,000 kg/mol, preferably from 100 to 1,000 kg/mol.

The polymer of the invention preferably has a density of radiation curable groups (molecular weight per group) from 50 to 500 kg/mol.

An object of the invention is also a method of preparation of a polymer as described herein, the method comprising the steps of:
(a) reacting a hydroxyl functionalized poly(meth)acrylate (co)polymer with an excess of at least one diisocyanate compound, so that the backbone of the resultant polyurethane polymer is terminated with isocyanate groups;
(b) then reacting the resultant of (a) with at least on hydroxyalkyl (meth)acrylate compound, so that the resultant polymer is terminated with (meth)acrylate groups.

An object of the invention is also a radiation or thermally curable adhesive composition for providing a pressure sensitive adhesive or a laminating adhesive, comprising at least one polymer as described herein.

The adhesive composition preferably comprises at least one further additive selected from tacikifiers, photoinitiators, further binders, stabilizers, fillers, flow control agents, thickeners, wetting agents, defoamers, crosslinkers, plasticizers, ageing inhibitors, fungicides, pigments, dyes, matting agents, and neutralizing agents. The adhesive composition preferably comprises from 20 wt % to 90 wt % of one or more polymers of the invention as described herein and at least 10 wt % of one or more tackifiers. The adhesive composition preferably comprises at least one photoinitiator in an amount of preferably from 0.1 to 5 wt. %, based on polymer amount.

Tackifiers are known per se to the skilled person. They are additives for adhesives or elastomers that improve the autoadhesion (tack, intrinsic stickiness, self-adhesion) of these systems. They generally have a relatively low molar mass (Mn about 200-2000 g/mol), a glass transition temperature which lies above that of the elastomers, and sufficient compatibility with the latter; in other words, the tackifiers dissolve at least partly in polymer films formed from the elastomers. The amount by weight of the tackifiers is preferably 5 to 100 parts by weight, more preferably 10 to 50 parts by weight, per 100 parts by weight of polymer (solid/solid). Suitable tackifiers are, for example, those based on natural resins, such as rosins, for example. Tackifiers based on natural resins include the natural resins themselves and also their derivatives formed, for example, by disproportionation or isomerization, polymerization, dimerization or hydrogenation. They may be present in their salt form (with, for example, monovalent or polyvalent counterions (cations)), or, preferably, in their esterified form. Alcohols used for the esterification may be monohydric or polyhydric. Examples are methanol, ethanediol, diethylene glycol, triethylene glycol, 1,2,3-propanetriol, and pentaerythritol. Also finding use as tackifiers, furthermore, are phenolic resins, hydrocarbon resins, e.g., coumarone-indene resins, polyterpene resins, terpene oligomers, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, alpha-methylstyrene, vinyltoluene. Also being used increasingly as tackifiers are polyacrylates which have a low molar weight. These polyacrylates preferably have a weight-average molecular weight Mw of below 30 000. The polyacrylates are composed preferably to an extent of at least 60%, more particularly at least 80%, by weight of C₁-C₈ alkyl (meth)acrylates. Preferred tackifiers are natural or chemically modified rosins. Rosins are composed predominantly of abietic acid or derivatives thereof.

For initial crosslinking, the compositions may in particular comprise at least one UV photoinitiator. Examples of photoinitiators are 1-hydroxycyclohexyl phenyl ketone, 2-hydroxy-2-methyl-1-phenyl-propan-1-one, diphenyl (2,4,6-trimethylbenzoyl) phosphine oxide, ethyl-2,4,6-trimethylbenzoyl phenylphosphinate, et al. The amount is generally 0.1 to 10 parts by weight, more particularly 0.5 to 5 parts by weight, per 100 parts by weight of polymer (solid).

For improved surface wetting, the compositions may in particular comprise wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, more particularly 0.1 to 3 parts by weight, per 100 parts by weight of polymer (solid).

Suitable stabilizers are e.g. selected from the group encompassing wetting agents, cellulose, polyvinyl alcohol, polyvinylpyrrolidone, and mixtures thereof.

Suitable further binders which may be used in addition to the polymer of the invention are e.g. polycondensates such as polyurethanes or free-radically polymerized polymers. Polymers of this kind consist preferably to an extent of at least 60% by weight of what are called principal monomers, selected from C₁ to C₂₀ alkyl (meth)acrylates, vinyl esters of carboxylic acids comprising up to 20 C atoms, vinyl aromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers. Polymers deserving particular mention are those composed to an extent of more than 60% by weight of C₁-C₂₀ alkyl (meth)acrylates (polyacrylates), or those composed to an extent of more than 60% by weight of styrene and 1,3-butadiene (styrene/butadiene copolymers, more particularly carboxylated styrene/butadiene copolymers). Carboxylated styrene/butadiene copolymers are formed from styrene, butadiene, and at least one ethylenically unsaturated, free-radically polymerizable monomer having at least one carboxyl group, such as acrylic acid, methacrylic acid, fumaric acid, itaconic acid, etc., preferably acrylic acid.

In one particular embodiment the adhesive compositions comprise no other kinds of binders. In another embodiment the adhesive compositions comprise 1 to 50 parts by weight, or 10 to 50 parts by weight, or 20 to 50 parts by weight, based on the sum of all the polymers, of further binders, preferably polyacrylates, polyurethanes and/or styrene/butadiene copolymers.

An object of the invention is also the use of a polymer of the invention as an adhesive, preferably as a pressure-sensitive adhesive.

An object of the invention is also a method for adhesively bonding substrates, where
a) a polymer of the invention as described herein is provided,
b) the polymer is applied to at least a first substrate, and
c) the applied polymer layer is cured thermally and/or by radiation,
d) the substrate coated with the polymer is contacted with a coated or un-coated second substrate,
   and the curing taking place before or after the two substrates are contacted with one another.

The substrates may be selected, for example, from polymer films, paper, metal foils, wood veneer, fiber nonwovens made of natural synthetic fibers, shaped solid articles, examples being shaped parts made of metal, painted metal, wood, woodbase materials, fiber materials or plastic. Particularly preferred first substrates are polymer films. Polymer films are, more particularly, flexible sheetlike plastics in a thickness of 0.05 millimeter to 5 millimeters, which can be rolled up. Consequently, in addition to “films” in the strict sense of thicknesses below 1 mm, the term also extends to sealing sheets, of the kind typically used for sealing tunnels, roofs or swimming pools, in a thickness typically of 1 to 3 mm, and even, in special cases, in a thickness of up to a maximum of 5 mm. Polymeric films of this kind are produced typically by coating, casting, calendering or extrusion and are typically available commercially in rolls or are produced on site. They may be of single-layer or multilayer construction. The plastic of the polymer films is preferably a thermoplastic, e.g., polyesters, such as polyethylene terephthalate (PET), thermoplastic polyolefins (TPO) such as polyethylene, polypropylene, polyvinyl chloride, especially plasticized PVC, polyacetates, ethylene/vinylacetate copolymers (EVA), ASA (acrylonitrile/styrene/acrylate), PU (polyurethane), PA (polyamide), poly(meth)acrylates, polycarbonates, or their plastics alloys, including, in particular foamed PVC films and foamed thermoplastic polyolefin films (TPO). Particularly preferred are PVC and thermoplastic polyolefins (TPO). The shaped parts may also be moldings composed of synthetic or natural fibers or chips bound together by a binder to form a molding; also suitable in particular are moldings made of plastic, e.g., ABS. The moldings may have any desired shape.

The substrates or moldings can be coated with the adhesive by customary application techniques, as for example by spraying, spreading, knife coating, die application, roll application or casting application methods.

The amount of coating or of adhesive applied is preferably 0.5 to 100 g/m², more preferably 2 to 80 g/m², very preferably 10 to 70 g/m². Preferably either only one substrate to be adhesively bonded, such as only the film or only the molding, for example, is coated on one side. Also suitable, however, is the coating of both substrates to be adhesively bonded, or of film and molding. Following the coating operation, there is typically a drying operation, preferably at room temperature or at temperatures up to 80° C., in order to remove water or other solvents.

The molding or substrate coated with a composition of the invention may be stored prior to curing. Flexible substrates may be wound up into rolls, for example. For curing, the coating is activated thermally or by electromagnetic radiation, preferably UV-radiation. For this purpose, the temperature in the coating is preferably at least 20° C. or at least 30° C. or at least 50° C., as for example from 20 to 200° C., or from 30 to 180° C. or from 50 to 80° C.

Compositions of the invention can be used for producing pressure-sensitive adhesive articles, or articles which have been rendered self-adhesive. The adhesive article may be a label. A preferred label is a self-adhesive paper label or film label, the adhesive being applied to paper or to a film as carrier material. The adhesive article may also be an adhesive tape, where the adhesive is applied to a tape-type carrier material. The carrier material of the adhesive tape may comprise woven or nonwoven fabrics, films, paper, felts, foams, and coextrudates, or combinations of these. Fields of application are carrierless tapes, single-sided and double-sided adhesive tapes, medical adhesive tapes, adhesive packaging tapes, cable wrapping tapes, carpet laying tapes, adhesive assembly tapes, adhesive tapes for fixing roofing felt sheets, carrier materials which have been rendered self-adhesive, such as foams, for example, bitumen sheets, and the like. The invention accordingly also provides for the use of PSA compositions of the invention for producing self-adhesive articles, more particularly for producing adhesive tapes for the fixing of components, more particularly in automobile construction, for electronics articles or in construction applications.

For the production of the adhesive articles, a layer of adhesive can be applied to the carrier material in a customary way, as for example by rolling, knife coating, spreading, etc. Where an aqueous adhesive dispersion is used, the water can be removed by drying at 50 to 150° C., for example. The coated substrates thus obtained are used, for example, as self-adhesive articles, such as labels, adhesive tapes or sheets. For this purpose, before or after the adhesive is applied, the carriers can be cut to form adhesive tapes, labels or sheets. For subsequent use, the PSA-coated side of the substrates may be lined with a release paper, such as with a siliconized paper, for example.

The invention also provides an adhesive tape which has at least one carrier layer and is coated on one or both sides with at least one PSA composition of the invention. Preferred carrier materials for producing adhesive tapes are polyethylene (PE), oriented polypropylene (oPP), polyethylene terephthalate (PET), PE foam, and polyurethane foam (PU foam). For the production of adhesive tapes, the application weight of the PSA composition, based on solids content, is preferably at least 20 g/m² or at least 30 g/m², e.g., 60 to 80 g/m². One embodiment of the invention is an adhesive tape where the material of the carrier layer is selected from PE, oPP, PET, PE foam, and PU foam and/or the adhesive tape has at least one detachable protective layer lining the layer of adhesive.

### EXAMPLES

### Abbreviations and Compounds

nBA n-butyl acrylate
poly(nBAx) polymer comprising x nBA units
St styrene
Dymerex® Tackifier; polymerized rosin; composed predominately of dimeric acids derived from rosin with lesser amounts of monomeric resin acids and neutral materials of rosin origin.
Foralyn®-90 tackifier, glycerol ester of hydrogenated rosin
Lucirin® TPO-L photoinitiator; Ethyl-2,4,6-Trimethylbenzoylphenylphosphinate
acResin® A260UV UV-reactive, solvent-free acrylic copolymer
HDPE high density polyethylene

### Intermediate 1

Intermediate 1 was prepared according to Example 2 of WO2011120947: controlled OH telechelic poly(nBA30).

### Intermediate 2

Intermediate 2 was prepared according to Example 3 of WO2011120947:
controlled OH telechelic poly(nBA35)

### Intermediate 3

Intermediate 3 was prepared according to Example 12 of WO2011120947: controlled OH telechelic poly(nBA270)

### Intermediate 4

Intermediate 4 was prepared according to Example 16 of WO2011120947: controlled OH telechelic poly(nBA35-b-St10)

### EXAMPLE 1

28.6 g hexamethylene diisocyanate, 250 g toluene, 190 g Intermediate 1 and 0.5 g dibutyl zinn dilaurate were charged into a 2 L reactor and cooked at 80° C. for 1 hour. While an “Intermediate 1 solution” was made by mixing 285 g Intermediate 1 and 300 g toluene. The “Intermediate 1 solution” was slowly added into the reactor at 80° C. in 1 hour. The reactor was held at 80° C. for further 3 hours. The a mixture of 15 g 2-hydroxyl ethyl acrylate, 0.5 g butylated hydroxyl toluene and 0.1 g p-methoxyphenol was added into the reactor and cooked until the NCO peak is disappeared in infrared spectra. Finally, a viscous liquid (Example 1) was obtained:

Mw˜200 kg/mol, Mn˜44 kg/mol, PDI˜4.6 (by gel permeation chromatography-GPC, THF 1 mL/min, and Polystyrene as standard).

### EXAMPLE 2

31.9 g hexamethylene diisocyanate, 250 g toluene, 200 g Intermediate 2 and 0.5 g dibutylzinndilaurate were charged into a 2 L reactor and cooked at 80° C. for 1 hour. While an “Intermediate 2 solution” was made by mixing 300 g Intermediate 2 and 300 g toluene. The “Intermediate 2 solution” was slowly added into the reactor at 80° C. in 1 hour. The reactor was held at 80° C. for further 3 hours. The a mixture of 15 g 2-hydroxyl ethyl acrylate, 0.5 g butylated hydroxyl toluene and 0.1 g p-methoxyphenol was added into the reactor and cooked until the NCO peak is disappeared in infrared spectra. Finally, a viscous liquid (Example 2) was obtained:

Mw˜180 kg/mol, Mn˜35 kg/mol, PDI˜5.0.

### EXAMPLE 3

3.5 g hexamethylene diisocyanate, 250 g toluene, 200 g Intermediate 3 and 0.5 g dibutylzinndilaurate were charged into a 2 L reactor and cooked at 80° C. for 1 hour. While an “Intermediate 3 solution” was made by mixing 300 g Intermediate 3 and 300 g toluene. The “Intermediate 3 solution”was slowly added into the reactor at 80° C. in 1 hour. The reactor was held at 80° C. for further 3 hours. The a mixture of 15 g 2-hydroxyl ethyl acrylate, 0.5 g butylated hydroxyl toluene and 0.1 g p-methoxyphenol was added into the reactor and cooked until the NCO peak is disappeared in infrared spectra. Finally, a viscous liquid (Example 3) was obtained:

Mw˜150 kg/mol, Mn˜40 kg/mol, PDI˜3.8.

### EXAMPLE 4

26.7 g hexamethylene diisocyanate, 250 g toluene, 200 g Intermediate 4 and 0.5 g dibutylzinndilaurate were charged into a 2 L reactor and cooked at 80° C. for 1 hour. While an “Intermediate 4 solution” was made by mixing 300 g Intermediate 4 and 300 g toluene. The “Intermediate 4 solution” was slowly added into the reactor at 80° C. in 1 hour. The reactor was held at 80° C. for further 3 hours. The a mixture of 15 g 2-hydroxyl ethyl acrylate, 0.5 g butylated hydroxyl toluene and 0.1 g p-methoxyphenol was added into the reactor and cooked until the NCO peak is disappeared in infrared spectra. Finally, a viscous liquid (Example 4) was obtained:

Mw˜190 kg/mol, Mn˜30 kg/mol, PDI˜6.3.

### EXAMPLE 5

41.9 g 2,4-toluene diisocyanate, 250 g toluene, 200 g Intermediate 2 and 0.5 g dibutylzinndilaurate were charged into a 2 L reactor and cooked at 80° C. for 1 hour. While an “Intermediate 2 solution” was made by mixing 300 g Intermediate 2 and 300 g toluene. The “Intermediate 2 solution” was slowly added into the reactor at 80° C. in 1 hour. The reactor was held at 80° C. for further 3 hours. The a mixture of 15 g 2-hydroxyl ethyl acrylate, 0.5 g butylated hydroxyl toluene and 0.1 g p-methoxyphenol was added into the reactor and cooked until the NCO peak is disappeared in infrared spectra. Finally, a viscous liquid (Example 5) was obtained:

Mw˜290 kg/mol, Mn˜40 kg/mol, PDI˜7.2.

Radiation Curable Pressure Sensitive Adhesive (PSA) Formulations:

The Examples in solution form with 50 wt % concentration are blended with the tackifier agents (Table 1) and 1 wt % s/s photoinitiator Lucirin® TPO-L (BASF) in the reactor. The resins were applied by a heated (110° C.) spreader with a quantity of 60 g/m² to a polyethylene terephthalate film. Then, the film was exposed under UV light (H-spectrum, H_{g}-mean pressure, 120 w/cm, UV-C dosage 65 mJ/cm²).

Test Procedures:

The film was cut in 25 mm width panels, then an area of 25*25 mm² film was glued on to the surface of steel. The tape was rolled with a weight of 1 kg one time and stored in standard climate (23° C., 1 bar, 50% relative humidity) for 10 min. Afterwards, it is kept hanging with a weight of 1 kg (same conditions as before). Shear strength is determined by the time till the falling down of the weight. The result is based on the average of 5 time measures.

The film was cut in 25 mm width panels and then glued on to the surface of steel and rolled with a weight of 1 kg one time. After 24 hours, one end of the samples was clamped into a tension testing equipment. The adhesive was pulled off with 300 mm/min with an angle of 180°. The peel strength was determined by the force needed in this process (N/25 mm). The result is based on the average of 5 time measures.

TABLE 1
Radiation curable PSA formulations

| Formulation | Examples | Tackifier agent | Lucirin TPO-L |
|---|---|---|---|
| F1 | Nr. 1 | Dymerex ® | 1 g |
| | 69 g polymer | 30 g | |
| F2 | Nr. 2 | Dymerex ® | 1 g |
| | 79 g polymer | 20 g | |
| F3 | Nr. 2 | Dymerex ® | 1 g |
| | 69 g polymer | 30 g | |
| F4 | Nr. 2 | Foralyn-90 ® | 1 g |
| | 69 g polymer | 30 g | |
| F5 | Nr. 2 | Foralyn-90 ® | 1 g |
| | 59 g polymer | 40 g | |
| F6 | Nr. 3 | Foralyn-90 ® | 1 g |
| | 59 g polymer | 40 g | |
| F7 | Nr. 4 | Dymerex ® | 1 g |
| | 69 g polymer | 30 g | |
| F8 | Nr. 5 | Dymerex ® | 1 g |
| | 69 g polymer | 30 g | |
| F9 | acResin ® A260 UV | | |

Performance Tests

The performances of Formulations F1 to F8 were tested, compared with a comparative UV-curable, polyacrylate-based pressure-sensitibve adhesive composition (acResin® A260UV, from BASF). The results are summarized in table 2.

TABLE 2
Performance of the PSA formulations

| | Sheer strength [min] | | Peel strength [N/25 mm] | |
|---|---|---|---|---|
| Formulation | 23° C., 1 kg | 70° C., 500 g | Steel | HDPE |
| F1 | 172 | 11 | 23 | 7.5 |
| F2 | 117 | 10 | 32 | 4 |
| F3 | 244 | 13 | 16 | 6.5 |
| F4 | 415 | 11 | 23 | 10.5 |
| F5 | 78 | 10 | 12 | 4 |
| F6 | 100 | 7 | 31 | 10 |
| F7 | 120 | 7 | 29 | 10 |
| F8 | 78 | 10 | 12 | 4 |
| F9 | 32 | 10 | 15 | 5 |

The performance of the Formulations F1 to F8 was generally very good with satisfactory results, e.g. high peel strength and acceptable high temperature performance with improvements in shear strength.

1. A polymer comprising a polyurethane backbone which is endcapped with reactive (meth)acrylic terminating groups, wherein the polyurethane backbone comprises a polymerized residue of a poly(meth)acrylate polyol.

2. The polymer according to claim 1, wherein the reactive (meth)acrylic terminating group is a residue of a hydroxyalkyl (meth)acrylate.

3. The polymer according to claim 1, wherein the poly(meth)acrylate polyol is a poly(meth)acrylate diol which is a reaction product of a dihydroxy monovinyl ether and a living polymerization system controlled poly(meth)acrylate.

4. The polymer according to claim 1, wherein the polymer is a structure of formula I: 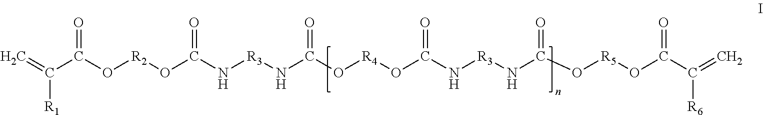
wherein,
R₁ and R₆ are each independently hydrogen or C₁₋₅₀ hydrocarbon fragment,
R₂ and R₅ are each independently C₁₋₅₀ hydrocarbylene,
R₃ is C₁₋₁₀₀ alkyl, aryl, heteroaryl, substituted aryl, or substituted heteroaryl,
R₄ is poly(meth)acrylate segment, and
n is a number of from 1 to 1000.

5. The polymer according to claim 4, wherein R₄ is a structure of formula II, wherein when q=0, the polymer is a homopolymer segment of (meth)acrylate monomers and when q is greater than 0, the polymer is a copolymer of (meth)acrylate monomers and other vinyl monomers: 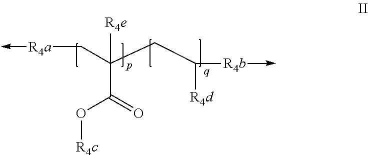
wherein,
R₄ₐ and R_{4b} are each independently an organic residue having 1 to 50 carbon atoms,
R_{4c} is hydrogen, alkyl, aryl, heteroaryl or substituted aryl,
R_{4d} is aryl, heteroaryl, substituted aryl,
R₄ₑ is hydrogen or C₁₋₅₀ hydrocarbon fragment,
p is a number of from 1 to 500, and
q is a number of from 0 to 100.

6. The polymer of claim 1, wherein the polymer has a weight average molecular weight measured by gel permeation chromatography of from 100 to 5,000 kg/mol.

7. The polymer of claim 1, wherein the polymer has a density of radiation curable groups (molecular weight per group) of from 50 to 500 kg/mol.

8. The polymer according to claim 1, wherein the polyurethane backbone, based on a total weight of the monomers used to form the polyurethane backbone, is synthesized to an extent of at least 40% by weight from diisocyanates and the poly(meth)acrylate polyol.

9. The polymer according to claim 1, wherein the polyurethane backbone is synthesized from
a) a monomeric diisocyanate,
b) a poly(meth)acrylate polyol
c) optionally a further diol different from component (b) comprising a diol having a number-average molecular weight of from 500 to 5000 g/mol,
d) optionally a monomer, different from the monomers (a) to (c), having an isocyanate group or a group reactive toward isocyanate groups, and additionally carrying a hydrophilic group or potentially hydrophilic group,
e) optionally a further compound, different from the monomers (a) to (d), having at least two reactive groups selected from alcoholic hydroxyl groups, primary or secondary amino groups or isocyanate groups, and
f) optionally a monofunctional compound, different from the monomers (a) to (f), having a reactive group which is an alcoholic hydroxyl group, a primary or secondary amino group or an isocyanate group.

10. The polymer according to claim 1, wherein the diisocyanate is at least one selected from the group consisting of 2,4- or 2,6-toluene diisocyanate, diphenyl methane-4,4′-diisocyanate, hydrogenated or non-hydrogenated m-tetramethylene xylene diisocyanate, hexamethylene diisocyanate, isophorone diisocyanate, dicyclohexylmethane diisocyanate, norbornane diisocyanate, 1,5-naphthylene diisocyanate, and dimethoxybenzidine diisocyanate.

11. A method of preparation of a polymer according to claim 1, comprising:
(a) reacting a hydroxyl functionalized poly(meth)acrylate (co)polymer with an excess of a diisocyanate compound, so that a backbone of the resultant polyurethane polymer is terminated with isocyanate groups; and
(b) then reacting the resultant of (a) with a hydroxyalkyl (meth)acrylate compound, so that the resultant polymer is terminated with (meth)acrylate groups.

12. A radiation or thermally curable adhesive composition, comprising at least one polymer according to claim 1.

13. The composition according to claim 12 comprising at least one further additive selected from the group consisting of tackifiers, photoinitiators, further binders, stabilizers, fillers, thickeners, wetting assistants, defoamers, crosslinkers, ageing inhibitors, fungicides, pigments, soluble dyes, matting agents, and neutralizing agents.

14. The composition according to claim 12, comprising from 20 wt % to 90 wt % of the polymers; and at least 10 wt % of a tackifier.

15. Composition according to claim 12, comprising a photoinitiator in an amount of from 0.5 to 5 wt. %, based on the polymer amount.

16. The polymer according to claim 1, wherein the polymer is suitable as an adhesive.

17. A method for adhesively bonding substrates, comprising
applying a polymer according to claim 1,
to at least a first substrate,
curing the applied polymer layer thermally and/or by radiation, and
contacting the substrate coated with the polymer with a coated or un-coated second substrate,
wherein the curing takes place before or after the two substrates are contacted with one another.
